(19) United States
(12) Patent Application Publication
(10) Pub. No.: US 2025/0163677 A1
(43) Pub. Date: May 22, 2025

(54) OPERATION LEVER AND CONSTRUCTION MACHINE

(71) Applicant: Yanmar Holdings Co., Ltd., Osaka (JP)

(72) Inventors: Taro OKAMATSU, Osaka (JP); Naohito YOSHIOKA, Osaka (JP); Nobuyuki ARAKI, Osaka (JP); Tomohiro KIMURA, Osaka (JP); Yuzhuo SHU, Osaka (JP)

(73) Assignee: Yanmar Holdings Co., Ltd., Osaka (JP)

(21) Appl. No.: 18/950,079

(22) Filed: Nov. 16, 2024

(30) Foreign Application Priority Data
Nov. 17, 2023 (JP) 2023-195629

(51) Int. Cl. E02F 9/20

(52) U.S. Cl. CPC E02F 9/2004

(57) ABSTRACT

An operation lever of a construction machine is constituted by integrally connecting a boom operation portion capable of operating a rotational-movement operation of a boom with respect to a machine body, an arm operation portion capable of operating the rotational-movement operation of an arm with respect to the boom, an attachment operation portion capable of operating an operation of an attachment, and a swing operation portion capable of operating a swing operation of the boom with respect to the machine body.

### DESCRIPTION

### Technical Field

The present invention relates to an operation lever and a construction machine including the operation lever.

### Background Art

A construction machine such as a backhoe (hydraulic excavator) includes an operating machine including a boom, an arm, and an attachment (a bucket, a grapple, or the like) in order to perform an excavation work or the like. In the construction machine, in addition to an operation of excavating/opening of the attachment, an operation of bending/stretching of the arm and an operation of the boom in an up-down direction, an operator needs to operate a swing operation to change a direction of the boom in a right-left direction with respect to a cabin and a right-left revolving operation of the entire operating machine including the cabin. A conventional construction machine includes two operation levers and a seesaw pedal and is configured to operate the operation of the boom, the arm, and the bucket in a front-rear direction of the bucket and a revolving operation of the entire operating machine by a front-rear/right-left movement of the two operation levers and to operate the swing operation of the boom by stepping on the seesaw pedal.

For example, according to Patent Document 1, a backhoe, which is a work vehicle, includes a work device, and the work device includes a boom, an arm, a bucket, which is a type of attachment, a boom cylinder, an arm cylinder, and an attachment cylinder. On a maneuvering portion of the back hoe, a right-side operation lever device and a left-side operation lever device are disposed, and each operation lever device is constituted capable of manipulating the boom cylinder, the arm cylinder and the attachment cylinder.

### PRIOR ART DOCUMENT

### Patent Document

Patent Document 1: Japanese Patent No. 6101498

### SUMMARY OF INVENTION

### Technical Problem

Meanwhile, in the construction machine, in addition to the operation in the front-rear direction of the boom, the arm, and the attachment, the swing operation of the boom, and the revolving operation of the entire operating machine, other operating devices such as a display device may be operated. However, the two operation levers need to be held by both hands in order to operate the boom, the arm, and the attachment in the front-rear direction or to operate the revolving operation of the entire operating machine and thus, the other operating devices cannot be operated by hand.

In addition, although the swing operation of the boom is the operation of the operating machine, it is operated not by the operation lever but by the seesaw pedal and thus, the use thereof is difficult, and the operability is lowered. While the boom, the arm, and the attachment are sequentially disposed in a longitudinal direction of front-rear/up-down, the two operation levers are disposed side by side in a lateral direction of the right-left direction and thus, a relation between an operation target and the operation levers is low, and an intuitive operation cannot be performed. Furthermore, although the boom, the arm, and the attachment are operated in the longitudinal direction of the front-rear/up-down, when the operation in the lateral direction of right-left of the operation lever is allocated, the relation between the movement direction of the operation target and the operation direction of the operation lever is low, and an intuitive operation cannot be performed, which may cause an erroneous operation.

An object of the present invention is to provide an operation lever and a construction machine capable of the intuitive operation of an operating machine and of operation of another operating device while operating the operating machine.

### Solution to Problem

In order to solve the above-described problems, the operation lever of the present invention is an operation lever of a construction machine, configured by integrally connecting a boom operation portion capable of operating a rotational-movement operation of the boom with respect to a machine body, an arm operation portion capable of operating a rotational-movement operation of the arm with respect to the boom, an attachment operation portion capable of operating an operation of the attachment, and a swing operation portion capable of operating a swing operation of the boom with respect to the machine body.

In addition, a construction machine of the present invention is characterized by including the above-described operation lever.

### Advantageous Effects of Invention

According to the present invention, an operation lever and a construction machine capable of intuitively operating an operating machine and of operating another operation device, while operating the operating machine can be provided.

### BRIEF DESCRIPTION OF DRAWINGS

FIG. 1 is a perspective view illustrating an example of a construction machine according to a first embodiment of the present invention;

FIG. 2 is a block diagram illustrating an example of an electric configuration of the construction machine according to the first embodiment of the present invention;

FIG. 3 is a perspective view illustrating an operation lever of the construction machine according to the first embodiment of the present invention from rear left;

FIG. 4 is a perspective view illustrating the operation lever of the construction machine according to the first embodiment of the present invention from rear right;

FIG. 5 is a side view illustrating the operation lever of the construction machine according to the first embodiment of the present invention from right;

FIG. 6 is a perspective view illustrating an operation lever of a construction machine according to a second embodiment of the present invention from rear left;

FIG. 7 is a side view illustrating the operation lever of the construction machine according to the second embodiment of the present invention from left;

FIG. 8 is a top view illustrating an attachment operation portion of the operation lever of the construction machine according to the second embodiment of the present invention; and FIG. 9 is a side view illustrating an operation lever of a construction machine according to a third embodiment of the present invention from rear left.

### DESCRIPTION OF EMBODIMENTS

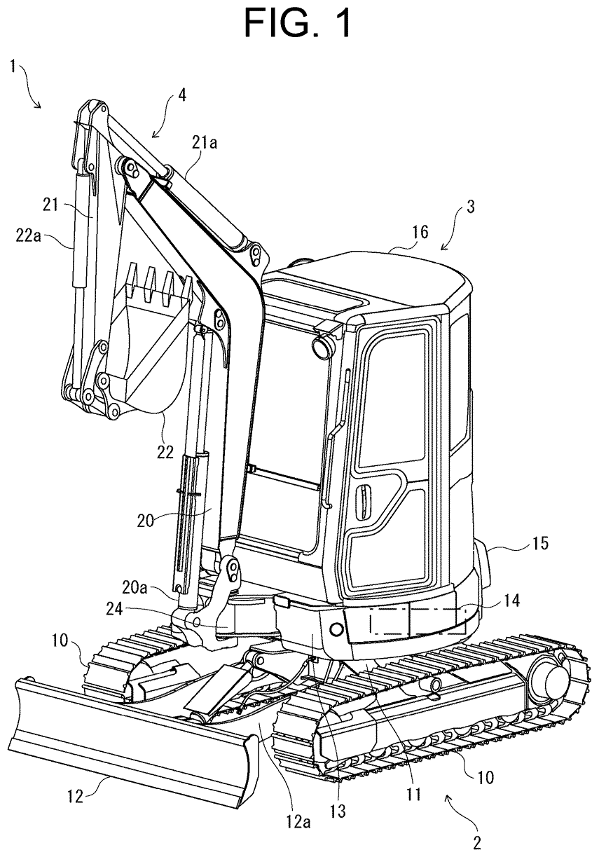

A construction machine 1 as a first embodiment of the present invention will be explained with reference to the drawings. FIG. 1 is a perspective view illustrating the construction machine 1 of the first embodiment.

The construction machine 1 is used at a construction site, a demolition site, a mine or the like, for example, and performs a work such as a civil engineering work, a construction work or the like in response to an operation of an operator. In the first embodiment, the construction machine 1 is constituted by a backhoe (hydraulic excavator) that performs an excavation work of earth and sand and the like. The construction machine 1 includes a lower traveling body 2, an upper revolving body 3, and an operating machine 4 and is configured as a work vehicle in which the upper revolving body 3 and the operating machine 4 are provided capable of revolving above the lower traveling body 2.

The lower traveling body 2 includes a pair of right and left crawlers 10, a track frame 11 that supports each crawler 10, and a blade 12 that functions as a blade for performing a ground leveling work or the like. The pair of crawlers 10 are driven by receiving power from a motor 14 provided in the upper revolving body 3 and performs traveling and the like of the construction machine 1. A track frame 11 is provided between the pair of crawlers 10 and supports the pair of crawlers 10 on both the right and left sides and supports the upper revolving body 3 capable of revolving. The blade 12 is attached to the track frame 11 via a blade arm 12a and is configured to rotationally move up and down by a blade cylinder (not shown).

The upper revolving body 3 includes a revolving frame 13, the motor 14, a counterweight 15, and a driving portion 16. The revolving frame 13 is swingably supported by the track frame 11 via a swivel joint (not shown) and is driven to revolve by a hydraulic motor (not shown). The motor 14 is constituted by, for example, an engine or an electric motor, is provided inside the machine body of the upper revolving body 3 below an operator's seat of the driving portion 16, and supplies power to each part of the construction machine 1. The counterweight 15 is attached to the rear side of the driving portion 16 and suppresses deviation of a center of gravity of the construction machine 1.

The driving portion 16 is provided on an upper part of the revolving frame 13 at the center in the right-left direction of the revolving frame 13. FIG. 1 shows an example in which the driving portion 16 is configured as a box-shaped cabin type, but in another example, the driving portion 16 may be configured to have another enclosure such as a canopy type. The driving portion 16 includes therein an operator seat on which an operator is seated, an operation portion 17 that receives an operation of the operator for traveling of the lower traveling body 2, revolving of the upper revolving body 3, a work of the operating machine 4 and the like, a display device 18 that displays various kinds of information and the like.

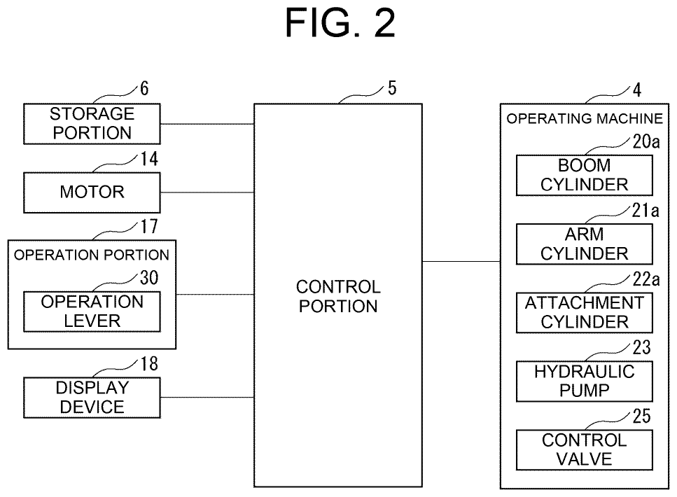

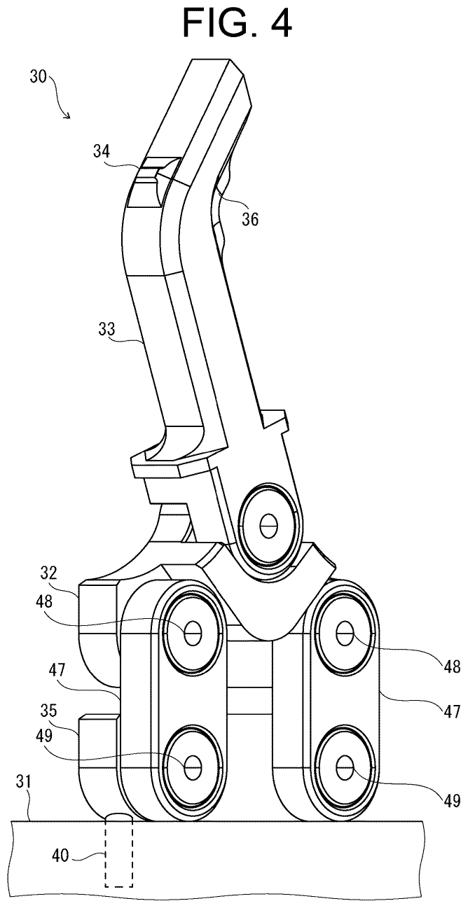

The operation portion 17 receives operations related to a traveling operation of the construction machine 1, a revolving operation of the machine body including the upper revolving body 3 and the operating machine 4, a work operation of the operating machine 4 and the like. In the first embodiment, in particular, the operation portion 17 includes the operation lever 30 (see FIGS. 2 and 3 to 5) that receives an operation related to a rotational-movement operation of the boom 20, the arm 21, and the attachment 22 of the operating machine 4 and a swing operation of the boom 20. Details of the operation lever 30 of the first embodiment will be described later.

The operating machine 4 performs various types of works such as the excavating work of earth and sand, a crushing work, an earth removal work and the like in accordance with the operation of the operator. The operating machine 4 is mounted on the revolving frame 13 in front of the driving portion 16. In the following description of the operating machine 4, a side close to the upper revolving body 3 is referred to as a base end side, and a side far from the upper revolving body 3 (a side close to the attachment 22) is referred to as a distal end side.

The operating machine 4 includes the boom 20, the arm 21, and the attachment 22. In the first embodiment, an example in which a bucket for an excavation work is provided as the attachment 22 of the operating machine 4 will be explained, but a grapple or the like may also be provided instead of the bucket.

The operating machine 4 is driven by hydraulic power of hydraulic fluid and includes a boom cylinder 20a, an arm cylinder 21a, and an attachment cylinder 22a as hydraulic actuators for driving the boom 20, the arm 21, and the attachment 22, respectively. The operating machine 4 uses the power generated by the motor 14 so as to supply the hydraulic fluid by a hydraulic pump 23 (see FIG. 2) from a hydraulic tank (not shown) to the boom cylinder 20a, the arm cylinder 21a, and the attachment cylinder 22a and to drive the boom cylinder 20a, the arm cylinder 21a, and the attachment cylinder 22a with the hydraulic fluid pressurized by the hydraulic pump 23 as a power transmission medium.

In the boom 20, a base end of the boom 20 is disposed at a front part of the revolving frame 13 of the upper revolving body 3, and the base end is supported capable of rotational movement in the front-rear direction (for example, a lower front or an upper rear direction) with respect to the revolving frame 13. The boom 20 is rotationally moved by the boom cylinder 20a, which is hydraulically driven with respect to the revolving frame 13.

Regarding the arm 21, a base end of the arm 21 is disposed at a distal end of the boom 20, and the base end is supported capable of rotational movement in the front-rear direction with respect to the boom 20. The arm 21 is rotationally moved by the arm cylinder 21a, which is hydraulically driven with respect to the boom 20.

The attachment 22 has a base end thereof disposed at a distal end of the arm 21, and the base end is supported rotationally movably in the front-rear direction with respect to the arm 21. The attachment 22 is rotatably moved by an attachment cylinder 22a, which is hydraulically driven with respect to the arm 21.

In addition, the operating machine 4 may include a swing mechanism 24 that enables the operating machine 4 to revolve in the right-left direction. The swing mechanism 24 pivotally supports the base end of the boom 20 capable of revolving in the right-left direction with respect to the front part of the revolving frame 13 of the upper revolving body 3 by a swing rotational-movement shaft (not shown) with the up-down direction as an axial direction. As a result, the operating machine 4 including the boom 20 can revolve in the horizontal direction with respect to the upper revolving body 3 including the revolving frame 13. The swing mechanism 24 includes a swing cylinder (not shown) that drives the boom 20 in the right-left direction with respect to the revolving frame 13. The swing cylinder drives the boom 20 with respect to the revolving frame 13 by the hydraulic fluid (hydraulic pressure) supplied from the hydraulic pump 23 and causes the operating machine 4 to perform a revolving operation (swing operation) with respect to the upper revolving body 3.

Note that a control valve 25 (see FIG. 2) that controls a supplied amount of the hydraulic fluid is provided between the boom cylinder 20a, the arm cylinder 21a, the attachment cylinder 22a, and the swing cylinder and the hydraulic pump 23. The control valve 25 is controlled in response to a control signal from a control portion 5 (see FIG. 2) so as to control the supply of the hydraulic fluid to the boom cylinder 20a, the arm cylinder 21a, the attachment cylinder 22a, and the swing cylinder.

As shown in FIG. 2, the construction machine 1 includes the control portion 5 that controls each portion of the construction machine 1 and a storage portion 6 that stores programs and data. The control portion 5 is constituted by a computer or the like such as a CPU (Central Processing Unit) or the like. The storage portion 6 is constituted by a ROM, a RAM, a hard disc drive and the like and stores a program and data for controlling each portion and various functions of the construction machine 1. The control portion 5 is connected to each portion of the construction machine 1 and controls each portion and the various functions by executing arithmetic processing on the basis of the program and data stored in the storage portion 6.

For example, the control portion 5 controls the control valve 25 in response to an operation signal from the operation lever 30 and executes control so as to perform the rotational-movement operations of the boom 20, the arm 21, and the attachment 22 and the swing operation of the boom 20 with an operated amount corresponding to the operated amount of the operation lever 30.

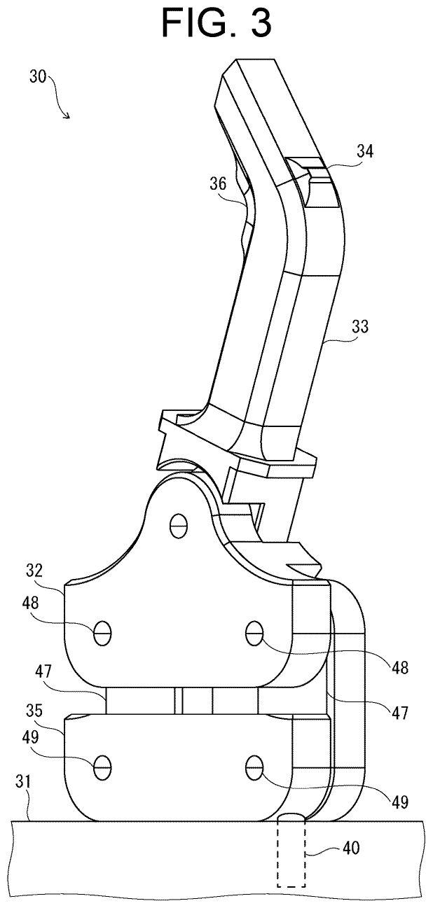

Subsequently, the operation lever 30 will be explained. The operation lever 30 is provided at any position within hand's reach of the operator seated on the driver's seat in the periphery of the driver's seat or may be provided at the center in the right-left direction in front of the driver's seat, for example, or may be provided on the front left side or the front right side of the driver's seat. Alternatively, the operation lever 30 may be provided on the left side or the right side of the driver's seat. As shown in FIGS. 3 to 5, the operation lever 30 is attached to a predetermined mount portion 31 in the periphery of the driver's seat.

The operation lever 30 is constituted by integrally connecting a boom operation portion 32 capable of operating the rotational-movement operation of the boom 20 with respect to the machine body of the upper revolving body 3, an arm operation portion 33 capable of operating the rotational-movement operation of the arm 21 with respect to the boom 20, an attachment operation portion 34 capable of operating the rotational-movement operation of the attachment 22 with respect to the arm 21, and a swing operation portion 35 capable of operating the swing operation of the boom 20 with respect to the machine body of the upper revolving body 3. In addition, the operation lever 30 includes a trigger switch 36 for operating optional operations other than the above-described basic operations for the boom 20, the arm 21, and the attachment 22.

The boom operation portion 32 is constituted to be operated in a first operation direction corresponding to the rotational-movement direction of the boom 20, the arm operation portion 33 is constituted to be operated in a second operation direction corresponding to the rotational-movement direction of the arm 21, the attachment operation portion 34 is constituted to be operated in a third operation direction corresponding to the rotational-movement direction of the attachment 22, and the swing operation portion 35 is operated in a fourth operation direction corresponding to the swing direction of the boom 20. The first operation direction of the boom operation portion 32, the second operation direction of the arm operation portion 33, and the third operation direction of the attachment operation portion 34 are set to directions different from one another.

Regarding the operation lever 30, the swing operation portion 35, the boom operation portion 32, the arm operation portion 33, and the attachment operation portion 34 are disposed in this order from the mount portion 31, which is a base portion of the operation lever 30, to a distal end. Specifically, the swing operation portion 35 is attached to the mount portion 31, the boom operation portion 32 is attached to the swing operation portion 35, the arm operation portion 33 is attached to the boom operation portion 32, and the attachment operation portion 34 is attached to the arm operation portion 33.

The swing operation portion 35 has a first rotation shaft 40 extending in the up-down direction, and the first rotation shaft 40 is attached to the mount portion 31. As a result, the swing operation portion 35 is provided capable of a rotation operation (capable of a twisting operation) in the horizontal direction with respect to the mount portion 31 as the fourth operation direction corresponding to the swing direction of the boom 20. Note that the first rotation shaft 40 may be fixed to the mount portion 31, while being pivotally and rotatably supported by the swing operation portion 35, or may be fixed to the swing operation portion 35, while being pivotally and rotatably supported by the mount portion 31.

For example, the swing operation portion 35 is formed having a substantially rectangular parallelepiped shape elongated in the front-rear direction. The first rotation shaft 40 is inserted into a shaft hole provided in a lower surface of a rear part of the swing operation portion 35, and a lower part of the first rotation shaft 40 protrudes downward from the lower surface of the rear part of the swing operation portion 35 and is inserted into a shaft hole provided in an upper surface of the mount portion 31. Regarding the operation lever 30, the swing operation of the boom 20 in the right-left direction is operated in accordance with the rotation operation in the right-left direction of the swing operation portion 35.

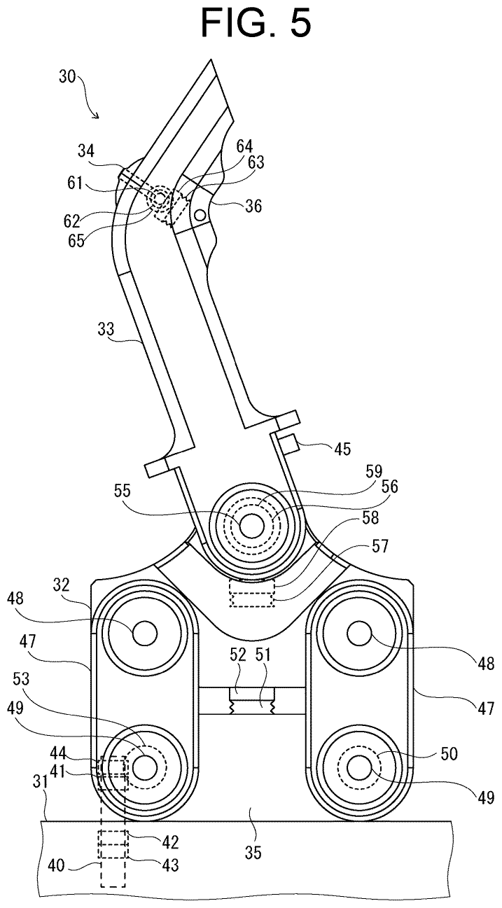

In addition, as shown in FIG. 5, the swing operation portion 35 includes a first angle sensor 41 that detects a rotation operated amount (twisting operated amount). The swing operation portion 35 transmits the rotation operated amount of the first angle sensor 41 to the control portion 5 so that the swing operation of the boom 20 is controlled by an operation amount (rotational movement amount) corresponding to the rotation operated amount (twisting operated amount) of the swing operation portion 35. For example, the first angle sensor 41 is provided on the first rotation shaft 40 and detects a rotation angle, thereby detecting a rotation operated amount of the swing operation portion 35.

In addition, as shown in FIG. 5, the swing operation portion 35 is rotationally operated in the horizontal direction with respect to a predetermined reference position (for example, a position at which the longitudinal direction thereof is disposed along the front-rear direction), and a first repulsive member 42 that applies a repulsive force for returning the swing operation portion 35 rotationally moved to the reference position is provided. In addition, the swing operation portion 35 includes a first repulsive-force adjustment device 43 capable of automatically or manually adjusting the repulsive force of the first repulsive member 42.

The first repulsive-force adjustment device 43 adjusts the repulsive force of the first repulsive member 42 in accordance with the control by the control portion 5, and may receive arbitrary setting of the repulsive force of the first repulsive member 42 from the operator via the display device 18, for example. The first repulsive member 42 and the first repulsive-force adjustment device 43 are provided on the first rotation shaft 40, for example. For example, the first repulsive member 42 is constituted by an urging member such as a spring, and the first repulsive-force adjustment device 43 adjusts the repulsive force of the first repulsive member 42 (the urging force of the urging member, for example) by adjusting a compression amount of the spring.

In addition, the swing operation portion 35 includes a first electromagnetic-load device 44 capable of automatic or manual adjustment of an operation load with respect to a rotational-movement operation in the horizontal direction of the swing operation portion 35. The first electromagnetic-load device 44 adjusts the operation load of the swing operation portion 35 in accordance with the control by the control portion 5 and preferably receives arbitrary setting of the operation load from the operator via the display device 18, for example. The first electromagnetic-load device 44 adjusts the difficulty of movement of the swing operation portion 35 by using a magnetic force and adjusts the operation load by adjusting the magnetic force. The first electromagnetic-load device 44 is provided on the first rotation shaft 40, for example.

The control portion 5 preferably learns the compression amount of the spring adjusted by the first repulsive-force adjustment device 43 and the operation load adjusted by the first electromagnetic-load device 44 and controls the first repulsive-force adjustment device 43 and the first electromagnetic-load device 44 so as to set the compression amount of the spring and the operation load with few errors.

In addition, the operation lever 30 includes a swing lock portion for locking the swing operation of the boom 20 by the swing operation portion 35 and a lock release portion 45 (see FIG. 5) for releasing the lock of the swing operation by the swing lock portion.

For example, the swing lock portion may be constituted by using the first electromagnetic-load device 44. When a predetermined lock condition is satisfied, the swing lock portion of the first electromagnetic-load device 44 switches the lock of the swing operation to ON and increases the operation load of the swing operation portion 35 so as to make the swing operation portion 35 inoperable. On the other hand, when the predetermined lock condition is not satisfied or when a predetermined unlock condition is satisfied, the swing lock portion of the first electromagnetic-load device 44 switches the lock of the swing operation to OFF, reduces the operation load of the swing operation portion 35, and enables the swing operation portion 35 to be operated.

Alternatively, the swing lock portion may be constituted by a program executed by the control portion 5. When the predetermined lock condition is satisfied, the swing lock portion of the control portion 5 switches the lock of the swing operation to ON and does not control the swing operation of the boom 20 regardless of the operation signal from the swing operation portion 35. On the other hand, when the predetermined lock condition is not satisfied or when the predetermined unlock condition is satisfied, the swing lock portion of the control portion 5 switches the lock of the swing operation to OFF and controls so as to perform the swing operation of the boom 20 in response to the operation signal from the swing operation portion 35.

The lock release portion 45 is provided at such a position that does not interfere with operations of the swing operation portion 35, the boom operation portion 32, the arm operation portion 33, and the attachment operation portion 34 and is constituted capable of operation by the operator's little finger or the like in the vicinity of the lower end of the arm operation portion 33, for example. When the lock release portion 45 is operated, it transmits a lock-release signal to the control portion 5, and a swing lock portion determines that a lock release condition is satisfied, when it receives the lock release signal.

The boom operation portion 32 is provided capable of a slide operation in the front-rear direction with respect to the swing operation portion 35 as the first operation direction corresponding to the rotational-movement direction of the boom 20. For example, the boom operation portion 32 is formed having a rectangular shape elongated in the front-rear direction in a top view and in a substantially convex shape in a side view. The boom operation portion 32 has a pair of front and rear leg portions 47 and is attached to the swing operation portion 35 via the pair of front and rear leg portions 47. The pair of front and rear leg portions 47 are rotatably supported with respect to the boom operation portion 32 and are rotatably supported with respect to the swing operation portion 35. The boom operation portion 32 becomes capable of a slide operation in the front-rear direction with respect to the swing operation portion 35 by the rotation of the pair of front and rear leg portions 47, that is, has a parallel link structure with respect to the swing operation portion 35.

Specifically, the boom operation portion 32 has a pair of front and rear second rotation shafts 48 extending in the right-left direction. The pair of front and rear second rotation shafts 48 are provided on a front part and a rear part of the boom operation portion 32, and since upper ends of the pair of front and rear leg portions 47 are pivotally supported by the pair of front and rear second rotation shafts 48, the pair of front and rear leg portions 47 are supported rotatably in the front-rear direction with respect to the boom operation portion 32. Furthermore, the boom operation portion 32 has a pair of front and rear third rotation shafts 49 extending in the right-left direction. The pair of front and rear third rotation shafts 49 are provided on a front part and a rear part of the swing operation portion 35, and since lower ends of the pair of front and rear leg portions 47 are pivotally supported by the pair of front and rear third rotation shafts 49, the pair of front and rear leg portions 47 are supported rotatably in the front-rear direction with respect to the swing operation portion 35. Regarding the operation lever 30, the rotational-movement operation in the front-rear direction of the boom 20 is operated in response to the slide operation in the front-rear direction of the boom operation portion 32.

In addition, as shown in FIG. 5, in order to detect the slide operated amount, the boom operation portion 32 includes a second angle sensor 50 that detects the rotation operated amount of the pair of front and rear leg portions 47, that is, the rotation operated amount of one of the second rotation shaft 48 and the third rotation shaft 49. Note that FIG. 5 illustrates an example in which the second angle sensor 50 is provided in the third rotation shaft 49 on the front side. The boom operation portion 32 transmits the rotation operated amount of the second angle sensor 50 to the control portion 5 so that the boom 20 is controlled by the operation amount (rotational movement amount) corresponding to the slide operated amount (rotation operated amount of the leg portion 47) of the boom operation portion 32. For example, the second angle sensor 50 is provided on one of the second rotation shaft 48 and the third rotation shaft 49 so as to detect a rotation angle and converts the detected rotation angle into a slide operated amount of the boom operation portion 32.

When the boom operation portion 32 is operated to slide in the front-rear direction with respect to a predetermined reference position (a position at which the pair of front and rear leg portions 47 are disposed along the up-down direction, for example), the boom operation portion 32 includes a second repulsive member 51 that applies a repulsive force for returning the slid boom operation portion 32 to the reference position. In addition, the boom operation portion 32 includes a second repulsive-force adjustment device 52 capable of automatically or manually adjusting the repulsive force of the second repulsive member 51.

The second repulsive-force adjustment device 52 preferably adjusts the repulsive force of the second repulsive member 51 in accordance with the control by the control portion 5 and receives arbitrary setting of the repulsive force of the second repulsive member 51 from the operator via the display device 18, for example. The second repulsive member 51 and the second repulsive-force adjustment device 52 are interposed between the swing operation portion 35 and the boom operation portion 32, for example. For example, the second repulsive member 51 is constituted by an urging member such as a spring, and the second repulsive-force adjustment device 52 adjusts the repulsive force of the second repulsive member 51 (the urging force of the urging member, for example) by adjusting a compression amount of the spring.

In addition, the boom operation portion 32 includes a second electromagnetic-load device 53 capable of automatically or manually adjusting the operation load to the slide operation in the front-rear direction of the boom operation portion 32. The second electromagnetic-load device 53 preferably adjusts the operation load of the boom operation portion 32 in accordance with the control by the control portion 5 and receives arbitrary setting of the operation load from the operator via the display device 18, for example. The second electromagnetic-load device 53 adjusts the difficulty of movement of the boom operation portion 32 by using a magnetic force and adjusts the operation load by adjusting the magnetic force. The second electromagnetic-load device 53 is provided on either one of the second rotation shaft 48 and the third rotation shaft 49, for example. Note that FIG. 5 illustrates an example in which the second electromagnetic-load device 53 is provided on the third rotation shaft 49 on the rear side.

The control portion 5 preferably learns the compression amount of the spring adjusted by the second repulsive-force adjustment device 52 and the operation load adjusted by the second electromagnetic-load device 53 and controls the second repulsive-force adjustment device 52 and the second electromagnetic-load device 53 so as to set the compression amount of the spring and the operation load with few errors.

In the first embodiment described above, an example has been described in which, in the operation lever 30, the boom operation portion 32 is capable of slide operation in the front-rear direction with respect to the swing operation portion 35 by a parallel link structure including the pair of front and rear leg portions 47, but the present invention is not limited to this example. In the other examples, the boom operation portion 32 may be constituted capable of the slide operation in the front-rear direction by being engaged with the swing operation portion 35 via a rail or a groove extending in the front-rear direction, for example.

The arm operation portion 33 is provided capable of a rotation operation in the front-rear direction with respect to the boom operation portion 32 as the second operation direction corresponding to the rotational-movement direction of the arm 21. For example, the arm operation portion 33 is formed of an elongated member that extends from the boom operation portion 32 in the upper front direction and then, curves and extends forward so as to be gripped by the operator. The arm operation portion 33 includes a fourth rotation shaft 55 extending in the right-left direction. The fourth rotation shaft 55 is pivotally supported by a convex part of the boom operation portion 32 and further, a lower end of the arm operation portion 33 is pivotally supported by the fourth rotation shaft 55, whereby the arm operation portion 33 is rotatably supported in the front-rear direction with respect to the boom operation portion 32 and moves so as to draw an arc around the fourth rotation shaft 55. Regarding the operation lever 30, a rotational-movement operation in the front-rear direction of the arm 21 is operated in accordance with the rotation operation in the front-rear direction of the arm operation portion 33.

In order to detect the rotation operated amount, the arm operation portion 33 includes a third angle sensor 56 that detects the rotation operated amount of the fourth rotation shaft 55. The arm operation portion 33 transmits the rotation operated amount of the third angle sensor 56 to the control portion 5 so that the arm 21 is controlled by the operated amount (rotational movement amount) corresponding to the rotation operated amount (rotation operated amount of the fourth rotation shaft 55) of the arm operation portion 33. The third angle sensor 56 is provided on the fourth rotation shaft 55, for example, and detects the rotation operated amount of the arm operation portion 33 by detecting the rotation angle of the fourth rotation shaft 55.

The arm operation portion 33 is rotated/operated in the front-rear direction with respect to a predetermined reference position (a position at which the arm operation portion 33 is disposed at a predetermined angle with respect to the horizontal direction, for example) and includes a third repulsive member 57 that applies a repulsive force for returning the rotated arm operation portion 33 to the reference position. In addition, the arm operation portion 33 includes a third repulsive-force adjustment device 58 capable of automatically or manually adjusting the repulsive force of the third repulsive member 57.

The third repulsive-force adjustment device 58 preferably adjusts the repulsive force of the third repulsive member 57 in accordance with the control by the control portion 5 and receives arbitrary setting of the repulsive force of the third repulsive member 57 from the operator via the display device 18, for example. The third repulsive member 57 and the third repulsive-force adjustment device 58 are provided below the lower end of the arm operation portion 33, for example. For example, the third repulsive member 57 is constituted by an urging member such as a spring, and the third repulsive-force adjustment device 58 adjusts the repulsive force of the third repulsive member 57 (the urging force of the urging member, for example) by adjusting a compression amount of the spring.

In addition, the arm operation portion 33 includes a third electromagnetic-load device 59 capable of automatically or manually adjusting the operation load with respect to the rotation operation in the front-rear direction of the arm operation portion 33. The third electromagnetic-load device 59 preferably adjusts the operation load of the arm operation portion 33 in accordance with the control by the control portion 5 and receives arbitrary setting of the operation load from the operator via the display device 18, for example. The third electromagnetic-load device 59 adjusts the difficulty of movement of the arm operation portion 33 by using a magnetic force and adjusts the operation load by adjusting the magnetic force. The third electromagnetic-load device 59 is provided on the fourth rotation shaft 55, for example.

The control portion 5 preferably learns the compression amount of the spring adjusted by the third repulsive-force adjustment device 58 and the operation load adjusted by the third electromagnetic-load device 59 and controls the third repulsive-force adjustment device 58 and the third electromagnetic-load device 59 so as to set the compression amount of the spring and the operation load with few errors.

The attachment operation portion 34 is provided capable of slide operation in the front-rear direction with respect to the arm operation portion 33 as the third operation direction corresponding to the rotational-movement direction of the attachment 22. For example, the attachment operation portion 34 is formed of an elongated member that extends from an inside of the arm operation portion 33 in the upper rear direction in the vicinity of a curved part of the arm operation portion 33. An upper end of the attachment operation portion 34 is exposed above the arm operation portion 33 and constitutes a knob portion operated by the thumb of an operator.

The attachment operation portion 34 includes a fifth rotation shaft 61 extending in the right-left direction. The fifth rotation shaft 61 is pivotally supported by an inside of the arm operation portion 33 in the vicinity of the curved part of the arm operation portion 33, and in addition, the lower end of the attachment operation portion 34 is pivotally supported by the fifth rotation shaft 61, whereby the attachment operation portion 34 is supported rotatably in the front-rear direction with respect to the arm operation portion 33. Since the attachment operation portion 34 becomes rotatable, the knob portion configured at the upper end of the attachment operation portion 34 becomes capable of the slide operation in the front-rear direction on the upper surface of the arm operation portion 33. Regarding the operation lever 30, a rotational-movement operation in the front-rear direction of the attachment 22 is operated in accordance with the rotation operation in the front-rear direction of the attachment operation portion 34.

In order to detect the slide operated amount, the attachment operation portion 34 includes a fourth angle sensor 62 that detects the rotation operated amount of the attachment operation portion 34, that is, the rotation operated amount of the fifth rotation shaft 61. The attachment operation portion 34 transmits the rotation operated amount of the fourth angle sensor 62 to the control portion 5 so that the attachment 22 is controlled by the operation amount (rotational movement amount) corresponding to the slide operated amount of the attachment operation portion 34 (rotation operated amount of the attachment operation portion 34). The fourth angle sensor 62 detects a rotation angle of the fifth rotation shaft 61 and converts the rotation angle of the fifth rotation shaft 61 into a slide operated amount of the attachment operation portion 34, for example.

The attachment operation portion 34 is operated to slide in the front-rear direction with respect to a predetermined reference position and includes a fourth repulsive member 63 that applies a repulsive force for returning the slid attachment operation portion 34 to the reference position. In addition, the attachment operation portion 34 includes a fourth repulsive-force adjustment device 64 capable of automatically or manually adjusting the repulsive force of the fourth repulsive member 63.

It is preferable that the fourth repulsive-force adjustment device 64 adjusts the repulsive force of the fourth repulsive member 63 in accordance with the control by the control portion 5 and receives arbitrary setting of the repulsive force of the fourth repulsive member 63 from the operator via the display device 18, for example. The fourth repulsive member 63 and the fourth repulsive-force adjustment device 64 are provided on the fifth rotation shaft 61. For example, the fourth repulsive member 63 is constituted by an urging member such as a spring, and the fourth repulsive-force adjustment device 64 adjusts the repulsive force of the fourth repulsive member 63 (the urging force of the urging member, for example) by adjusting a compression amount of the spring.

In addition, the attachment operation portion 34 includes a fourth electromagnetic-load device 65 capable of automatically or manually adjusting an operation load with respect to the slide operation in the front-rear direction of the attachment operation portion 34.

It is preferable that the fourth electromagnetic-load device 65 adjusts the operation load of the attachment operation portion 34 in accordance with the control by the control portion 5 and receives arbitrary setting of the operation load from the operator via the display device 18, for example. The fourth electromagnetic-load device 65 adjusts the difficulty of movement of the attachment operation portion 34 by using a magnetic force and adjusts the operation load by adjusting the magnetic force. The fourth electromagnetic-load device 65 is provided on the fifth rotation shaft 61, for example.

The control portion 5 preferably learns the compression amount of the spring adjusted by the fourth repulsive-force adjustment device 64 and the operation load adjusted by the fourth electromagnetic-load device 65 and controls the fourth repulsive-force adjustment device 64 and the fourth electromagnetic-load device 65 so as to set the compression amount of the spring and the operation load with few errors.

A trigger switch 36 is provided at such a position that does not interfere with the operations of the swing operation portion 35, the boom operation portion 32, the arm operation portion 33, and the attachment operation portion 34 and is provided on the lower surface of the arm operation portion 33 in the vicinity of the curved part of the arm operation portion 33, for example. The trigger switch 36 is configured capable of operation in the front-rear direction and/or the right-left direction by the index finger of an operator, for example.

As described above, the trigger switch 36 is used for operating optional operations other than the basic operations of the boom 20, the arm 21, and the attachment 22 and operates a specific operation of an operation target arbitrarily set by the operator through the display device 18 or the like or a specific operation of a work member such as a bucket or a grapple attached as the attachment 22. For example, the trigger switch 36 becomes capable of opening/closing and rotation operations of a grapple provided as the attachment 22. The trigger switch 36 includes an angle sensor (not shown) that detects an operation in the front-rear direction and/or the right-left direction, and the angle sensor transmits an operated amount of the trigger switch 36 to the control portion 5.

As described above, according to the first embodiment, the operation lever 30 of the construction machine 1 is configured by integrally connecting the boom operation portion 32 capable of operating the rotational-movement operation of the boom 20 with respect to the machine body, the arm operation portion 33 capable of operating the rotational-movement operation of the arm 21 with respect to the boom 20, the attachment operation portion 34 capable of operating the operation of the attachment 22, and the swing operation portion 35 capable of operating the swing operation of the boom 20 with respect to the machine body. For example, the attachment operation portion 34 is configured capable of operation of a rotational-movement operation of the attachment 22 with respect to the arm 21.

As a result, by operating the operation lever 30 with one hand, the operator can operate the rotational-movement operations of the boom 20, the arm 21, and the attachment 22 of the construction machine 1 and the swing operation of the boom 20. Therefore, the operator can operate the other operation devices such as the display device 18 while operating the boom 20, the arm 21, and the attachment 22, whereby operation efficiency can be improved.

In addition, according to the first embodiment, the boom operation portion 32 is configured to be operated in the first operation direction corresponding to the rotational-movement direction of the boom 20, the arm operation portion 33 is configured to be operated in the second operation direction corresponding to the rotational-movement direction of the arm 21, the attachment operation portion 34 is configured to be operated in the third operation direction corresponding to the rotational-movement direction of the attachment 22, and the swing operation portion 35 is operated in the fourth operation direction corresponding to the swing direction of the boom 20.

The rotational-movement direction of the boom 20, the rotational-movement direction of the arm 21, and the rotational-movement direction of the attachment 22 are operations in a vertical direction as viewed from the operator of the driving portion 16, while the swing direction of the boom 20 is an operation in a lateral direction as viewed from the operator of the driving portion 16. In contrast, the first operation direction of the boom operation portion 32, the second operation direction of the arm operation portion 33, and the third operation direction of the attachment operation portion 34 are operations in the vertical direction corresponding to the rotational-movement directions of the boom 20, the arm 21, and the attachment 22, and the fourth operation direction of the swing operation portion 35 is a lateral operation corresponding to the swing direction of the boom 20 and thus, a relation between the movement direction of the operation target and the operation direction of the operation lever 30 is high, and an intuitive operation can be performed, whereby an erroneous operation can be suppressed.

In addition, according to the first embodiment, the first operation direction of the boom operation portion 32, the second operation direction of the arm operation portion 33, and the third operation direction of the attachment operation portion 34 are set to directions different from one another.

As a result, since the operation of the boom operation portion 32, the operation of the arm operation portion 33, and the operation of the attachment operation portion 34 are distinguished by the operation direction, an erroneous operation can be suppressed.

In addition, according to the first embodiment, the operation lever 30 includes a swing lock portion capable of locking the operation of the swing operation of the boom 20 by the swing operation portion 35.

As a result, the erroneous operation of the swing operation of the boom 20 can be suppressed more reliably.

In addition, according to the first embodiment, the operation lever 30 includes the electromagnetic-load devices (the first electromagnetic-load device 44, the second electromagnetic-load device 53, the third electromagnetic-load device 59, and the fourth electromagnetic-load device 65) capable of adjusting the operation load of at least one of the boom operation portion 32, the arm operation portion 33, the attachment operation portion 34, and the swing operation portion 35.

As a result, the operation load can be set in accordance with the operator or the type of work and thus, an erroneous operation can be suppressed more reliably.

In addition, according to the first embodiment, regarding the operation lever 30, the swing operation portion 35, the boom operation portion 32, the arm operation portion 33, and the attachment operation portion 34 are disposed in this order from the mount portion 31, which is the base portion of the operation lever 30, to the distal end.

As a result, since the disposition of the swing operation portion 35, the boom operation portion 32, the arm operation portion 33, and the attachment operation portion 34 corresponds to the disposition of the swing mechanism 24, the boom 20, the arm 21, and the attachment 22, an erroneous operation can be suppressed more reliably.

In addition, according to the first embodiment, the swing operation portion 35 is configured to be rotatable in the right-left direction with respect to the mount portion 31 as the base portion, the boom operation portion 32 is configured to be slidable with respect to the swing operation portion 35 with the sliding direction in the front-rear direction as the first operation direction, the arm operation portion 33 is configured to be rotationally movable with respect to the boom operation portion 32 with the rotational-movement direction in the front-rear direction as the second operation direction, and the attachment operation portion 34 is configured to be slidable with respect to the arm operation portion 33 with the sliding direction in the front-rear direction as the third operation direction.

As a result, since the operation directions of the swing operation portion 35, the boom operation portion 32, the arm operation portion 33, and the attachment operation portion 34 correspond to the movement directions of the swing mechanism 24, the boom 20, the arm 21, and the attachment 22, an erroneous operation can be suppressed more reliably.

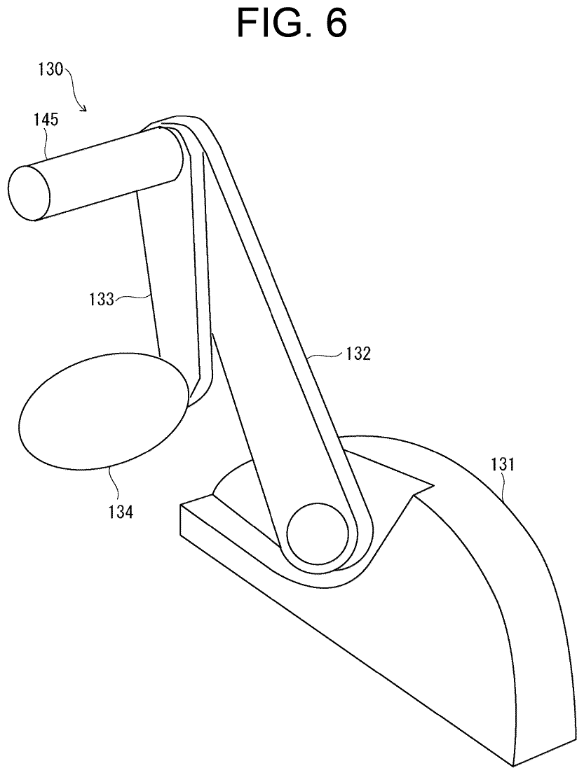

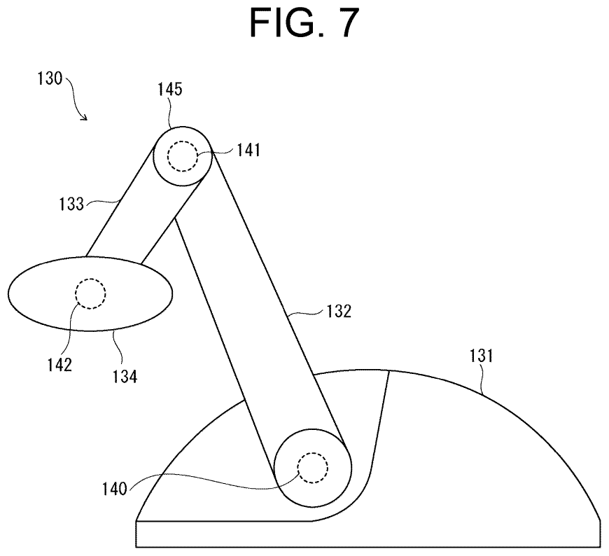

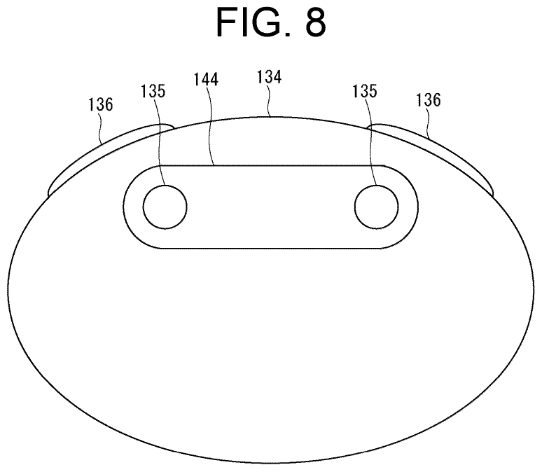

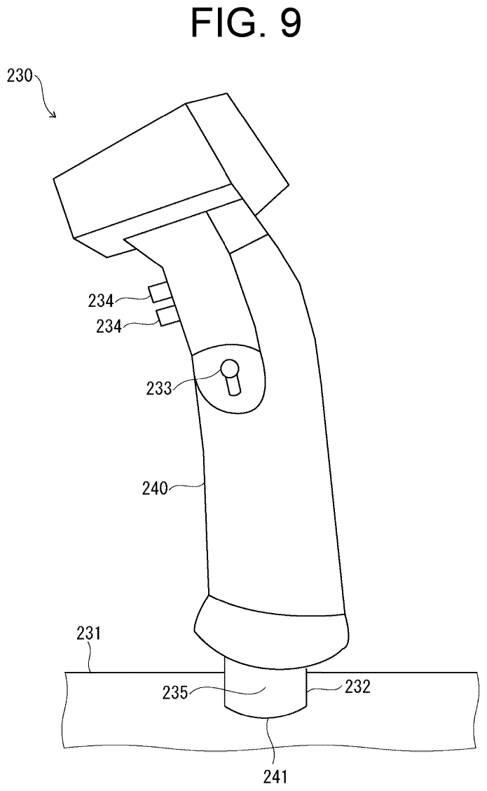

Note that, in the first embodiment described above, an example has been described in which, in the operation lever 30, the boom operation portion 32 is configured to be slidable with the sliding direction in the front-rear direction as the first operation direction, and the attachment operation portion 34 is configured to be slidable with the sliding direction in the front-rear direction as the third operation direction, but the present invention is not limited to this example. For example, in the second embodiment, as shown in FIG. 6 and FIG. 7, in the operation lever 130, the boom operation portion 132 is configured to be rotatable with the rotation direction in the front-rear direction as the first operation direction, and the attachment operation portion 134 is configured to be rotatable with the rotation direction in the up-down direction as the third operation direction. Specifically, the boom operation portion 132 is attached to the mount portion 131, which is the base portion, the arm operation portion 133 is attached to the boom operation portion 132, and the attachment operation portion 134 is attached to the arm operation portion 133. Note that, as shown in FIG. 8, the swing operation portion 135 is provided in the attachment operation portion 134.

The boom operation portion 132 is provided capable of a rotation operation in the front-rear direction with respect to the mount portion 131 as the first operation direction corresponding to the rotational-movement direction of the boom 20. For example, the boom operation portion 132 is formed by an elongated member that extends upward from the mount portion 131. The boom operation portion 132 has, as shown in FIG. 7, a sixth rotation shaft 140 extending in the right-left direction. The sixth rotation shaft 140 is pivotally supported by the mount portion 131 and moreover, the lower end of the boom operation portion 132 is pivotally supported by the sixth rotation shaft 140 and thus, the boom operation portion 132 is supported rotatably in the front-rear direction with respect to the mount portion 131 and moves so as to draw an arc around the sixth rotation shaft 140. The operation of the boom operation portion 132 with respect to the mount portion 131 is similar to the operation of the boom 20 with respect to the machine body (revolving frame 13) of the upper revolving body 3. With the operation lever 130, a rotational-movement operation in the front-rear direction of the boom 20 is operated in accordance with the rotation operation in the front-rear direction of the boom operation portion 132. Note that, at the distal end (upper end) of the boom operation portion 132, a sub-operation lever 145 for operating only the boom operation portion 132 is provided. The sub-operation lever 145 is coaxial with a seventh rotation shaft 141 of the arm operation portion 133 and is provided by protruding laterally (to the left side, for example) with respect to the boom operation portion 132, for example.

The arm operation portion 133 is provided capable of a rotation operation in the front-rear direction with respect to the boom operation portion 132 as the second operation direction corresponding to the rotational-movement direction of the arm 21. For example, the arm operation portion 33 is formed by an elongated member extending downward from the distal end (upper end) of the boom operation portion 132. As shown in FIG. 7, the arm operation portion 133 has the seventh rotation shaft 141 extending in the right-left direction.

The seventh rotation shaft 141 is pivotally supported by the distal end of the boom operation portion 132 and moreover, the upper end of the arm operation portion 133 is pivotally supported by the seventh rotation shaft 141, whereby the arm operation portion 133 is supported so as to be rotatable in the front-rear direction with respect to the boom operation portion 132 and moves so as to draw an arc around the seventh rotation shaft 141. The operation of the arm operation portion 133 with respect to the boom operation portion 132 is similar to the operation of the arm 21 with respect to the boom 20. With the operation lever 130, a rotational-movement operation in the front-rear direction of the arm 21 is operated in accordance with the rotation operation in the front-rear direction of the arm operation portion 133.

The attachment operation portion 134 is provided capable of a rotation operation in the up-down direction with respect to the arm operation portion 133 as the third operation direction corresponding to the rotational-movement direction of the attachment 22. For example, the attachment operation portion 134 is formed having an ellipsoidal shape to be gripped by the operator. As shown in FIG. 7, the attachment operation portion 134 has an eighth rotation shaft 142 extending in the right-left direction.

The eighth rotation shaft 142 is pivotally supported by the distal end (lower end) of the arm operation portion 133 and moreover, a center shaft in the right-left direction of the attachment operation portion 134 is pivotally supported by the eighth rotation shaft 142, whereby the attachment operation portion 134 is supported capable of rotation in the up-down direction with respect to the arm operation portion 33 and moves so as to draw an arc around the eighth rotation shaft 142. The operation of the attachment operation portion 134 with respect to the arm operation portion 133 is similar to the operation of the attachment 22 with respect to the arm 21. With the operation lever 130, a rotational-movement operation in the front-rear direction of the attachment 22 is operated in accordance with the rotation operation in the up-down direction of the attachment operation portion 134.

The operation lever 130 of the second embodiment has a so-called palm-type operation portion shape on which the palm of the operator is placed by forming the attachment operation portion 134 having an ellipsoidal shape to be gripped by the operator. As shown in FIG. 8, a recessed portion 144 is provided on the upper surface of the attachment operation portion 134, and the swing operation portion 135 for operating the swing operation of the boom 20 is provided in the recessed portion 144 by a pair of left and right operation buttons. The swing operation portion 135 is provided in the recessed portion 144 so as not to be operated by the palm placed on the attachment operation portion 134. In addition, on a side surface of the attachment operation portion 134 or on the left front surface and the right front surface, for example, a revolving operation portion 136 for operating a revolving operation of the machine body including the upper revolving body 3 and the operating machine 4 is provided by a pair of right and left operation buttons.

The swing operation portion 135 is provided capable of a pressing operation in a pressing direction of the left-side operation button and a pressing direction of the right-side operation button as the fourth operation direction corresponding to the swing direction of the boom 20. With the operation lever 130, the swing operation in the right-left direction of the boom 20 is operated in accordance with the left-side or right-side pressing operation of the swing operation portion 135. The swing operation portion 135 transmits the operation signal corresponding to the pressing operation to the control portion 5 so that the swing operation of the boom 20 is controlled by an operation amount (rotational movement amount) corresponding to the pressing operation.

The revolving operation portion 136 is provided capable of the pressing operation in the pressing direction of the left-side operation button and the pressing direction of the right-side operation button as the operation direction corresponding to the revolving direction of the machine body. With the operation lever 130, the revolving operation in the right-left direction of the machine body is operated in accordance with the left-side or right-side pressing operation of the revolving operation portion 136. The revolving operation portion 136 transmits the operation signal corresponding to the pressing operation to the control portion 5 so that the revolving operation of the machine body is controlled by an operation amount (rotational movement amount) corresponding to the pressing operation.

Note that, though not shown, the operation lever 130 in the second embodiment may include a repulsive member that applies a repulsive force for returning the boom operation portion 132, the arm operation portion 133, and the attachment operation portion 134 to the reference position and a repulsive-force adjustment device that can automatically or manually adjust the repulsive force, respectively, similarly to the first embodiment. In addition, the operation lever 130 in the second embodiment may include a repulsive-force adjustment device capable of automatically or manually adjusting the operation load to the operations of the boom operation portion 132, the arm operation portion 133, and the attachment operation portion 134, respectively, similarly to the first embodiment. In addition, the operation lever 130 in the second embodiment may include a swing lock portion that locks the swing operation of the boom 20 by the swing operation portion 135 and a lock release portion that releases the lock of the swing operation by the swing lock portion similarly to the first embodiment.

In the second embodiment described above, an example has been described in which the boom operation portion 132 is attached to the left side of the mount portion 131, the arm operation portion 133 is attached to the left side of the boom operation portion 132, and the attachment operation portion 134 is attached to the left side of the arm operation portion 133, but the present invention is not limited to this example. In another example, the boom operation portion 132 may be attached to the right side of the mount portion 131, the arm operation portion 133 may be attached to the right side of the boom operation portion 132, and the attachment operation portion 134 may be attached to the right side of the arm operation portion 133. Alternatively, in another example, by attaching a pair of the arm operation portions 133 to both the right and left sides of the attachment operation portion 134 and a pair of right and left boom operation portions 132 to the pair of right and left arm operation portions 133, the attachment operation portion 134 may be constituted not as cantilevered but supported at both ends.

As described above, according to the second embodiment, in the operation lever 130 of the construction machine 1, the boom operation portion 132 is formed to extend upward from the mount portion 131, which is the base portion, and is constituted to be rotatable with the rotation direction in the front-rear direction around the sixth rotation shaft 140 provided on the mount portion 131 as the first operation direction, the arm operation portion 133 is formed to extend downward from the distal end (upper end) of the boom operation portion 132 and is constituted to be rotatable with the rotation direction in the front-rear direction around the seventh rotation shaft 141 provided on the distal end of the boom operation portion 132 as the second operation direction, and the attachment operation portion 134 is formed having an ellipsoidal shape and is constituted to be rotatable with the rotation direction in the up-down direction around the eighth rotation shaft 142 provided on the distal end (lower end) of the arm operation portion 133 as the third operation direction.

As a result, since the disposition and the operation directions of the boom operation portion 32, the arm operation portion 33, and the attachment operation portion 34 correspond to be substantially the same as the disposition and the operation directions of the boom 20, the arm 21, and the attachment 22, the relation between the movement direction of the operation target and the operation direction of the operation lever 30 is high, and a more intuitive operation can be performed and thus, an erroneous operation can be suppressed more reliably.

Note that, in the first embodiment and the second embodiment described above, regarding the operation levers 30, 130, such examples were explained that the arm operation portions 33, 133 are attached to the boom operation portions 32, 132 and the attachment operation portions 34, 134 are attached to the arm operation portions 33, 133, but the present invention is not limited to these examples. For example, in a third embodiment, as shown in FIG. 9, an operation lever 230 may include a lever main body 240, and a boom operation portion 232, an arm operation portion 233, an attachment operation portion 234, and a swing operation portion 235 may be attached to the lever main body 240. As a result, the boom operation portion 232, the arm operation portion 233, the attachment operation portion 234, and the swing operation portion 235 are integrally connected via the lever main body 240.

The lever main body 240 is formed by an elongated member extending upward from a mount portion 231, which is a base portion of the operation lever 230. The lever main body 240 has a ninth rotation shaft 241 extending in the up-down direction, a lower end of the ninth rotation shaft 241 is attached to the mount portion 231, and an upper end of the ninth rotation shaft 241 is attached to the lower end of the lever main body 240.

The swing operation portion 235 is constituted by the ninth rotation shaft 241 described above. For example, the swing operation portion 235 is fixed to the lever main body 240 and is pivotally supported rotatably so as to incline in the right-left direction with respect to the mount portion 231. Alternatively, the swing operation portion 235 is fixed to the lever main body 240 and is pivotally supported rotatably in the horizontal direction with respect to the mount portion 231 (so as to be rotatable clockwise or counterclockwise in a top view). As a result, the swing operation portion 235 is provided capable of rotating operation in the right-left direction or the horizontal direction with respect to the mount portion 31 as the fourth operation direction corresponding to the swing direction of the boom 20. With the operation lever 230, the swing operation in the right-left direction of the boom 20 is operated in accordance with the rotation operation of the swing operation portion 235 in the right-left direction or the horizontal direction.

The boom operation portion 232 is constituted by the ninth rotation shaft 241 described above. For example, the boom operation portion 232 is fixed to the lever main body 240 and is pivotally supported rotatably so as to incline in the front-rear direction with respect to the mount portion 231. As a result, the boom operation portion 32 is provided capable of rotating operation in the front-rear direction with respect to the mount portion 231 as the first operation direction corresponding to the rotational-movement direction of the boom 20. With the operation lever 230, a rotational-movement operation in the front-rear direction of the boom 20 is operated in accordance with the rotation operation in the front-rear direction of the boom operation portion 232.

The arm operation portion 233 is provided at a position corresponding to the thumb of the operator gripping the lever main body 240 on a middle-part side surface (a left surface, for example) of the lever main body 240. For example, the arm operation portion 233 is pivotally supported rotatably so as to incline in the front-rear direction with respect to the lever main body 240. The arm operation portion 233 is provided capable of a rotation operation in the front-rear direction with respect to the lever main body 240 as the second operation direction corresponding to the rotational-movement direction of the arm 21. With the operation lever 230, a rotational-movement operation in the front-rear direction of the arm 21 is operated in accordance with the rotation operation in the front-rear direction of the arm operation portion 233.

The attachment operation portion 234 is provided at a position corresponding to the forefinger of the operator gripping the lever main body 240 on a middle-part side surface (a rear surface, for example) of the lever main body 240. For example, the attachment operation portion 234 is constituted by a pair of upper and lower operation buttons with respect to the lever main body 240. The attachment operation portion 234 is provided capable of a pressing operation in a pressing direction of the upper-side operation button and a pressing direction of the lower-side operation button as the third operation direction corresponding to the rotational-movement direction of the attachment 22. With the operation lever 130, a rotational-movement operation in the front-rear direction of the attachment 22 is operated in accordance with the upper-side or lower-side pressing operation of the attachment operation portion 234.

Note that, though not shown, the operation lever 230 of the third embodiment may include a repulsive member that applies a repulsive force for returning the boom operation portion 232, the arm operation portion 233, the attachment operation portion 234, and the swing operation portion 235 to the reference position and a repulsive force adjustment device that can automatically or manually adjust the repulsive force, respectively, similarly to the first embodiment. In addition, the operation lever 230 in the third embodiment may include a repulsive-force adjustment device capable of automatically or manually adjusting the operation load to the operations of the boom operation portion 232, the arm operation portion 233, the attachment operation portion 234, and the swing operation portion 235, respectively, similarly to the first embodiment. In addition, the operation lever 230 in the third embodiment may include a swing lock portion that locks the swing operation of the boom 20 by the swing operation portion 235 and a lock release portion that releases the lock of the swing operation by the swing lock portion similarly to the first embodiment.

In addition, the operation lever 230 of the third embodiment may include a trigger switch for operating optional operations other than the above-described basic operations for the boom 20, the arm 21, and the attachment 22 on the side surface of the lever main body 240 at a position where the operations of the swing operation portion 235, the boom operation portion 232, the arm operation portion 233, and the attachment operation portion 234 are not hindered.

Note that the present invention can be modified as appropriate without departing from the gist or the spirit of the invention that can be read from the claims and the entire specification, and an operation lever for a construction machine with such modifications and a construction machine including the operation lever are also included in the technical idea of the present invention.

### SUPPLEMENTARY NOTE OF THE INVENTION

Hereinafter, an outline of the invention extracted from the above-described embodiment will be supplementarily described. Note that each of configurations and processing functions described in the following supplementary notes may be selected and combined arbitrarily.

### Supplementary Note 1

An operation lever for a construction machine,
characterized by being constituted by integrally connecting a boom operation portion capable of operating a rotational-movement operation of a boom with respect to a machine body,
an arm operation portion capable of operating a rotational-movement operation of an arm with respect to the boom,
an attachment operation portion capable of operating an operation of an attachment, and
a swing operation portion capable of operating a swing operation of the boom with respect to the machine body.

### Supplementary Note 2

The operation lever described in Supplementary Note 1, in which the attachment operation portion is constituted capable of operating a rotational-movement operation of the attachment with respect to the arm.

### Supplementary Note 3

The operation lever described in Supplementary Note 2, in which the boom operation portion is constituted to be operated in a first operation direction corresponding to a rotational movement direction of the boom,
the arm operation portion is constituted to be operated in a second operation direction corresponding to a rotational movement direction of the arm,
the attachment operation portion is constituted to be operated in a third operation direction corresponding to a rotational movement direction of the attachment, and
the swing operation portion is constituted to be operated in a fourth operation direction corresponding to a swing direction of the boom.

### Supplementary Note 4

The operation lever described in Supplementary Note 3, in which the first operation direction of the boom operation portion, the second operation direction of the arm operation portion, and the third operation direction of the attachment operation portion are set to different directions, respectively.

### Supplementary Note 5

The operation lever according to any one of Supplementary Notes 1 to 4, further including a swing lock portion capable of locking an operation of a swing operation of the boom by the swing operation portion.

### Supplementary Note 6

The operation lever described in any one of Supplementary Notes 1 to 5, further including an electromagnetic-load device capable of adjusting an operation load of at least one of the boom operation portion, the arm operation portion, the attachment operation portion, and the swing operation portion.

### Supplementary Note 7

The operation lever according to any one of Supplementary Notes 1 to 6, in which the swing operation portion, the boom operation portion, the arm operation portion, and the attachment operation portion are disposed in this order from a base portion to a distal end of the operation lever.

### Supplementary Note 8

The operation lever according to any one of Supplementary Notes 3 to 7, in which the swing operation portion is constituted to be rotatable in a right-left direction with respect to the base portion,
the boom operation portion is constituted to be slidable with respect to the swing operation portion with a sliding direction in a front-rear direction as the first operation direction,
the arm operation portion is constituted to be rotatable with respect to the boom operation portion with a rotation direction in the front-rear direction as the second operation direction, and
the attachment operation portion is constituted to be slidable with respect to the arm operation portion with a sliding direction in the front-rear direction as the third operation direction.

### Supplementary Note 9

The operation lever described in any one of Supplementary Notes 3 to 7, in which the boom operation portion is formed to extend upward from the base portion and is constituted to be rotatable around a rotation shaft provided in the base portion with a rotation direction in a front-rear direction as the first operation direction,
the arm operation portion is formed to extend downward from a distal end of the boom operation portion and is constituted to be rotatable around a rotation shaft provided at the distal end of the boom operation portion with the rotation direction in the front-rear direction as the second operation direction, and
the attachment operation portion is formed having an ellipsoidal shape and is constituted to be rotatable around a rotation shaft provided at a distal end of the arm operation portion with a rotation direction in an up-down direction as the third operation direction.

### Supplementary Note 10

A construction machine characterized by including the operation lever described in any one of the Supplementary Notes 1 to 9.

### REFERENCE SIGNS LIST

1 Construction machine

2 Lower traveling body

3 Upper revolving body

4 Operating machine

5 Control portion

13 Revolving frame

14 Motor

16 Driving portion

17 Operation portion

18 Display device

20 Boom

20a Boom cylinder

21 Arm

21a Arm cylinder

22 Attachment

22a Attachment cylinder

24 Swing mechanism

25 Control valve

30, 130, 230 Operation lever

31, 131, 231 Mount portion

32, 132, 232 Boom operation portion

33, 133, 233 Arm operation portion

34, 134, 234 Attachment operation portion

35, 135, 235 Swing operation portion

36 Trigger switch

40 First rotation shaft

41 First angle sensor

42 First repulsive member

43 First repulsive-force adjustment device

44 First electromagnetic-load device

45 Lock release portion

47 Leg portion

48 Second rotation shaft

49 Third rotation shaft

50 Second angle sensor

51 Second repulsive member

52 Second repulsive-force adjustment device

53 Second electromagnetic-load device

55 Fourth rotation shaft

56 Third angle sensor

57 Third repulsive member

58 Third repulsive-force adjustment device

59 Third electromagnetic-load device

61 Fifth rotation shaft

62 Fourth angle sensor

63 Fourth repulsive member

64 Fourth repulsive-force adjustment device

65 Fourth electromagnetic-load device

1. An operation lever for a construction machine, characterized by integrally connecting:
a boom operation portion capable of operating a rotational-movement operation of a boom with respect to a machine body;
an arm operation portion capable of operating a rotational-movement operation of an arm with respect to the boom;
an attachment operation portion capable of operating an operation of an attachment; and
a swing operation portion capable of operating a swing operation of the boom with respect to the machine body.

2. The operation lever according to claim 1, wherein the attachment operation portion is constituted capable of operating a rotational-movement operation of the attachment with respect to the arm.

3. The operation lever according to claim 2, wherein the boom operation portion is constituted operably in a first operation direction corresponding to a rotational movement direction of the boom;
the arm operation portion is constituted operably in a second operation direction corresponding to a rotational movement direction of the arm;
the attachment operation portion is constituted operably in a third operation direction corresponding to a rotational movement direction of the attachment; and
the swing operation portion is constituted operably in a fourth operation direction corresponding to a swing direction of the boom.

4. The operation lever according to claim 3, wherein the first operation direction of the boom operation portion, the second operation direction of the arm operation portion, and the third operation direction of the attachment operation portion are set to different directions, respectively.

5. The operation lever according to claim 1, further comprising a swing lock portion capable of locking an operation of a swing operation of the boom by the swing operation portion.

6. The operation lever according to claim 1, further comprising an electromagnetic-load device capable of adjusting an operation load of at least one of the boom operation portion, the arm operation portion, the attachment operation portion, and the swing operation portion.

7. The operation lever according to claim 1, wherein the swing operation portion, the boom operation portion, the arm operation portion, and the attachment operation portion are disposed in this order from a base portion to a distal end of the operation lever.

8. The operation lever according to claim 3, wherein the swing operation portion is constituted rotatably in a right-left direction with respect to a base portion of the operation lever;
the boom operation portion is constituted slidably with respect to the swing operation portion in a sliding direction in a front-rear direction as the first operation direction;
the arm operation portion is constituted rotatably with respect to the boom operation portion in a rotation direction in the front-rear direction as the second operation direction, and
the attachment operation portion is constituted slidably with respect to the arm operation portion in a sliding direction in the front-rear direction as the third operation direction.

9. The operation lever according to claim 3, wherein the boom operation portion is formed to extend upward from a base portion of the operation lever and is constituted rotatably around a rotation shaft provided in the base portion with a rotation direction in a front-rear direction as the first operation direction;
the arm operation portion is formed to extend downward from a distal end of the boom operation portion and is constituted rotatably around a rotation shaft provided at the distal end of the boom operation portion with a rotation direction in the front-rear direction as the second operation direction; and
the attachment operation portion is formed in an ellipsoidal shape and is constituted rotatably around a rotation shaft provided at a distal end of the arm operation portion with a rotation direction in an up-down direction as the third operation direction.

10. A construction machine characterized by comprising the operation lever according to claim 1.
